(19) United States
(12) Patent Application Publication
(10) Pub. No.: US 2024/0281345 A1
(43) Pub. Date: Aug. 22, 2024

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Kodai UMEDA, Kanagawa (JP); Toshitsugu KIKUCHI, Kanagawa (JP); Kiwamu SATO, Kanagawa (JP)

(73) Assignee: FUJIFILM Business Innovation Corp., Tokyo (JP)

(21) Appl. No.: 18/447,799

(22) Filed: Aug. 10, 2023

(30) Foreign Application Priority Data
Feb. 17, 2023 (JP) 2023-023137

(51) Int. Cl. G06F 11/14

(52) U.S. Cl. CPC G06F 11/1471

(57) ABSTRACT

An information processing apparatus includes a log memory and a processor configured to obtain log information indicating an operation status of a log obtaining target device, which is at least a monitored processor or a peripheral device, which is a device in the information processing apparatus other than the monitored processor, and store the log information in the log memory, set a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor, stop, on a basis of the flag, obtaining the log information and cause the log memory to maintain the log information obtained so far before the log obtaining target device in the operation of which the abnormality has occurred is reset, and perform, without resetting the log memory after stopping obtaining the log information, reset control for resetting the log obtaining target device in the operation of which the abnormality has occurred.

### CROSS-REFERENCE TO RELATED APPLICATIONS

This application is based on and claims priority under 35 USC 119 from Japanese Patent Application No. 2023-023137 filed Feb. 17, 2023.

### BACKGROUND

### (i) Technical Field

The present disclosure relates to an information processing apparatus and a non-transitory computer readable medium.

### (ii) Related Art

In information processing apparatuses, abnormalities might occur in operation of processors (e.g., central processing units (CPUs)). A watchdog timer is known that detects an abnormality in operation of a monitored device such as a processor and that, if detecting an abnormality, resets and restarts a device from which the abnormality has been detected. Such a watchdog timer outputs a reset signal for resetting a monitored device if an initialization signal is not input from the monitored device within a certain period.

In an information processing apparatus, log information indicating an operation status of a device such as a processor is sometimes stored in a memory. A manager of the information processing apparatus usually desires to obtain log information at a time when an abnormality occurred in operation of a device, but if a memory storing log information is also reset after an abnormality occurs in operation of a device, the log information stored in the memory is undesirably deleted.

A technique for resetting, if an abnormality occurs in operation of a device, the device while obtaining log information, therefore, has been proposed.

Japanese Unexamined Patent Application Publication No. 2019-155686, for example, discloses an image forming apparatus including a watchdog timer that outputs a watchdog reset request if an initialization signal is not input within a certain period, a control circuit that inputs the initialization signal to the watchdog timer, a volatile memory, and a nonvolatile memory. The image forming apparatus resets only the control circuit if an abnormality occurs in operation of the control circuit and the watchdog reset request is output, maintains a log by storing information stored in the volatile memory in the nonvolatile memory as a log using the control circuit restarted as a result of the reset, and resets all reset targets in the image forming apparatus.

### SUMMARY

Because a log memory that stores log information regarding a processor or a peripheral device, which is a device in an information processing apparatus other than the processor (at least the processor or the peripheral device will be referred to as a “log obtaining target device” herein) has a finite storage capacity, oldest log information might be deleted from the log memory when new log information regarding the log obtaining target device is stored in the log memory. If log information continues to be obtained even after an abnormality occurs in operation of the log obtaining device, therefore, log information at a time when the abnormality occurred might be undesirably deleted from the log memory.

Aspects of non-limiting embodiments of the present disclosure relate to resetting, if an abnormality occurs in operation of a log obtaining target device in a case where log information regarding the log obtaining target device is stored in a log memory, the log obtaining device while obtaining the log information regarding the log obtaining target device at a time when the abnormality occurred.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a log memory and a processor configured to obtain log information indicating an operation status of a log obtaining target device, which is at least a monitored processor or a peripheral device, which is a device in the information processing apparatus other than the monitored processor, and store the log information in the log memory, set a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor, stop, on a basis of the flag, obtaining the log information and cause the log memory to maintain the log information obtained so far before the log obtaining target device in the operation of which the abnormality has occurred is reset, and perform, without resetting the log memory after stopping obtaining the log information, reset control for resetting the log obtaining target device in the operation of which the abnormality has occurred.

### BRIEF DESCRIPTION OF THE DRAWINGS

An exemplary embodiment of the present disclosure will be described in detail based on the following figures, wherein:

FIG. 1 is a schematic diagram illustrating the configuration of an information processing apparatus according to an exemplary embodiment;

FIG. 2 is a first flowchart illustrating a process performed by the information processing apparatus according to the exemplary embodiment; and

FIG. 3 is a second flowchart illustrating the process performed by the information processing apparatus according to the exemplary embodiment.

### DETAILED DESCRIPTION

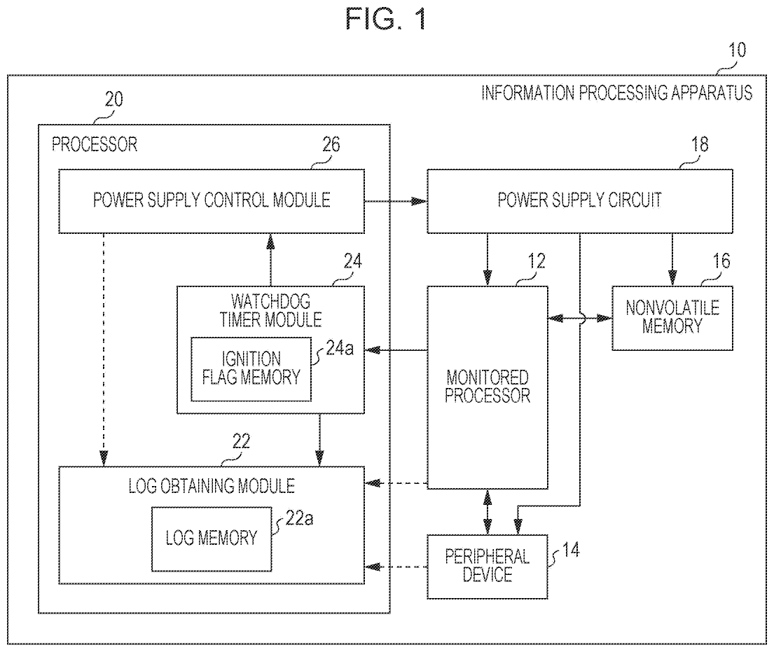

FIG. 1 is a schematic diagram illustrating the configuration of an information processing apparatus 10 according to an exemplary embodiment. The information processing apparatus 10 is an image processing apparatus such as a multifunction device, but the information processing apparatus 10 may be any apparatus capable of achieving functions that will be described later.

A monitored processor 12 is a device to be monitored by a watchdog timer module 24, which will be described later. In the present exemplary embodiment, the monitored processor 12 is a central processing unit (CPU) that controls other components of the information processing apparatus 10. Since the information processing apparatus 10 is an image processing apparatus in the present exemplary embodiment, the CPU controls various processes, such as a printing process and an image reading process, by operating together with, for example, a peripheral device 14, which will be described later.

As described in detail later, the monitored processor 12 regularly transmits, as long as operating properly, an initialization signal to a processor 20 (the watchdog timer module 24, more specifically), which will be described later. If the monitored processor 12 detects occurrence of an abnormality in operation of the peripheral device 14, the monitored processor 12 transmits, to the processor 20 (the watchdog timer module 24, more specifically), an abnormality signal indicating that the abnormality has occurred in the operation of the peripheral device 14. If the monitored processor 12 no longer receives a response from the peripheral device 14 while performing one of various processes through communication with the peripheral device 14, for example, the monitored processor 12 may determine that an abnormality has occurred in the operation of the peripheral device 14. The monitored processor 12 may also determine that an abnormality has occurred in the operation of the peripheral device 14 if the monitored processor 12 receives an error signal or the like from the peripheral device 14.

The peripheral device 14 performs, by operating together with the monitored processor 12, processing relating to various functions that can be executed by the information processing apparatus 10. The peripheral device 14 is an application-specific integrated circuit (ASIC), for example, but is not limited to this. The information processing apparatus 10 may be provided with plural peripheral devices 14.

A nonvolatile memory 16 includes a hard disk drive (HDD), a solid-state drive (SSD), an embedded MultiMediaCard (eMMC), a read-only memory (ROM), or the like. The nonvolatile memory 16 is a memory that maintains stored information even when power is no longer supplied.

The nonvolatile memory 16 stores a program for causing each component of the information processing apparatus 10 to operate. In particular, the nonvolatile memory 16 stores a program for processing information, the program causing the processor 20, which will be described later, to operate. The program for processing information may be stored in a non-transitory computer readable medium such as a universal serial bus (USB) memory or a compact disc read-only memory (CD-ROM), instead. The processor 20 is capable of loading the program from the medium and executing the program.

A power supply circuit 18 supplies power to various devices included in the information processing apparatus 10, such as the monitored processor 12, the peripheral device 14, and the nonvolatile memory 16. As described later, the processor 20 (especially a power supply control module 26) controls the supply of power to the various devices from the power supply circuit 18.

The term “processor 20” as a first processor, a second processor, and a third processor refers to hardware in a broad sense. The processor 20 includes at least a general processor (e.g., a CPU) or a dedicated processor (e.g., a GPU: Graphics Processing Unit, an ASIC, an FPGA: Field Programmable Gate Array, or a CPLD: Complex Programmable Logic Device). The term “processor 20” is broad enough to encompass one processor or plural processors in collaboration which are located physically apart from each other but may work cooperatively. The processor 20 includes a memory (e.g., a cache memory) therein.

As illustrated in FIG. 1, the processor 20 achieves functions as a log obtaining module 22, the watchdog timer module 24, and the power supply control module 26. A “module” herein refers to a set of functions achieved by hardware (the processor 20 in the present exemplary embodiment) and software (the program for processing information in the present exemplary embodiment).

The log obtaining module 22 obtains log information indicating an operation status of at least the monitored processor 12 or the peripheral device 14. As described above, at least the monitored processor 12 or the peripheral device 14 will be referred to as a “log obtaining target device” herein. In the present exemplary embodiment, the log obtaining module 22 also obtains log information indicating an operation status of the power supply control module 26, which will be described later. In FIG. 1, flow of the log information is indicated by broken lines. The log obtaining module 22 stores the obtained log information in a log memory 22a defined in the log obtaining module 22. The log memory 22a need not necessarily be defined in the log obtaining module 22 (i.e., the processor 20).

The log obtaining module 22 sequentially obtains the log information in accordance with the operation of the monitored processor 12, the peripheral device 14, and the power supply control module 26 and stores the log information in the log memory 22a. Because the log memory 22a has a finite storage capacity, the log obtaining module 22 deletes old log information stored in the log memory 22a when storing new log information if the log memory 22a is full. The log memory 22a has a ring buffer structure, for example, and the log obtaining module 22 deletes the oldest log information from the log memory 22a when storing new log information.

In the present exemplary embodiment, the log obtaining module 22 is provided for the processor 20, which is different from the monitored processor 12. As a result, in the present exemplary embodiment, the obtaining of log information from the monitored processor 12 can be started before power is supplied to the monitored processor 12 by supplying power to the processor 20 (i.e., the log obtaining module 22) prior to the monitored processor 12 when the information processing apparatus 10 is turned on or recovered from a sleep state (a state where power is supplied to only some devices (a communication unit (not illustrated) that receives information from external apparatuses and an input interface (not illustrated) for receiving user inputs) of the information processing apparatus 10). The log obtaining module 22 can thus obtain log information when the monitored processor 12 is turned on. When the monitored processor 12 is turned on, an abnormality is more likely to occur than after the monitored processor 12 is turned on, and therefore the obtaining of log information when the monitored processor 12 is turned on is effective.

The watchdog timer module 24 monitors the monitored processor 12 and detects occurrence of an abnormality in the operation of the monitored processor 12. More specifically, the watchdog timer module 24 includes a counter (not illustrated) and gradually decreases a value of the counter (counter value) from a certain value. When the counter value reaches 0, the watchdog timer module 24 determines that an abnormality has occurred in the operation of the monitored processor 12. Time taken for the counter value to reach 0 from the certain value is also called a “timeout period”. A manager of the information processing apparatus 10 may appropriately set the timeout period. The timeout period is set, for example, at tens of milliseconds.

As described above, the monitored processor 12 transmits the initialization signal to the watchdog timer module 24. The initialization signal is used to reset the counter value of the watchdog timer module 24 (reset to the certain value in the present exemplary embodiment). The monitored processor 12 transmits, as long as operating properly, transmits the initialization signal to the watchdog timer module 24 in each timeout period before the counter value of the watchdog timer module 24 becomes 0. If an abnormality occurs in the operation of the monitored processor 12 and the monitored processor 12 can no longer transmit the initialization signal, the counter value of watchdog timer module 24 becomes 0, and the watchdog timer module 24 determines that an abnormality has occurred in the operation of the monitored processor 12.

Although the watchdog timer module 24 uses a down counter, which gradually decreases a counter value, in the above example, the watchdog timer module 24 may use an up counter, which gradually increases a counter value, instead. In this case, the watchdog timer module 24 determines that an abnormality has occurred in the operation of the monitored processor 12 when the counter value reaches a certain value, and resets the counter value to 0 in accordance with the initialization signal from the monitored processor 12.

As described above, the monitored processor 12 transmits, to the watchdog timer module 24, an abnormality signal indicating that an abnormality has occurred in the peripheral device 14. When there are plural peripheral devices 14, an abnormality signal may include information with which one of the peripheral devices 14 can be identified. The watchdog timer module 24 receives an abnormality signal from the monitored processor 12 and determines that an abnormality has occurred in the operation of a certain one of the peripheral devices 14.

As described above, the watchdog timer module 24 detects occurrence of an abnormality in the operation of a log obtaining target device (the monitored processor 12 or the peripheral device 14) in accordance with absence of the initialization signal input from the monitored processor 12 within a certain period (timeout period) or an abnormality signal input from the monitored processor 12.

Upon detecting an abnormality in the operation of the log obtaining target device, the watchdog timer module 24 sets a watchdog ignition flag, which indicates occurrence of an abnormality in the operation of the log obtaining target device. In the present exemplary embodiment, the watchdog timer module 24 stores the watchdog ignition flag in an ignition flag memory 24a defined in the watchdog timer module 24. The watchdog timer module 24 notifies the log obtaining module 22 of the setting of the watchdog ignition flag.

A general watchdog timer module issues a reset request to a module that performs reset control (the power supply control module 26 in the present exemplary embodiment) immediately after the watchdog ignition flag is set. In the present exemplary embodiment, however, the watchdog timer module 24 does not issue a reset request to the power supply control module 26 when the watchdog ignition flag is set.

More specifically, when the watchdog ignition flag is set, the log obtaining module 22 stops obtaining log information on the basis of the watchdog ignition flag before the power supply control module 26 performs the reset control. As a result, since new log information is not written to the log memory 22a, old log information stored in the log memory 22a is not deleted. In other words, the log memory 22a maintains log information obtained so far. The log obtaining module 22 may set a log latch flag, which indicates that the obtaining of log information has been stopped, for example, and store the log latch flag in the log memory 22a.

After the log obtaining module 22 stops obtaining log information, the watchdog timer module 24 issues a reset request to the power supply control module 26. The watchdog timer module 24 may detect that the log obtaining module 22 has stopped obtaining log information by reading the log latch flag stored in the log memory 22a or issue a reset request when a sufficient period of time for the log obtaining module 22 to stop obtaining log information has passed since the watchdog ignition flag was set. The watchdog timer module 24 may detect that the log obtaining module 22 has stopped obtaining log information by receiving, from the log obtaining module 22, a notification indicating that the log obtaining module 22 has stopped obtaining log information.

The power supply control module 26 is a module for controlling the power supply circuit 18. Under control of the power supply control module 26, the power supply circuit 18 supplies power to the devices included in the information processing apparatus 10. The power supply control module 26 can reset (restart) the devices by controlling the power supply circuit 18 such that the power supply circuit 18 temporarily stops supplying power to the devices and then supplies power to the devices again. The power supply control module 26 thus functions as a reset control module.

Upon receiving a reset request from the watchdog timer module 24, the power supply control module 26 performs reset control for resetting the log obtaining target device in the operation of which an abnormality has occurred. Here, the log memory 22a is not a target of the reset control performed by the power supply control module 26. That is, the power supply control module 26 does not reset the log memory 22a even if the watchdog ignition flag is set. As a result, the log information stored in the log memory 22a is not deleted. When the log memory 22a is provided inside the log obtaining module 22, the log obtaining module 22 need not be a target of the reset control.

In the present exemplary embodiment, the power supply control module 26 does not reset the processor 20 including the log obtaining module 22. In the present exemplary embodiment, the power supply control module 26 resets the devices included in the information processing apparatus 10 other than the processor 20, such as the monitored processor 12 and the peripheral device 14 (i.e., the log obtaining target devices), in accordance with the watchdog ignition flag.

If a log obtaining target device in the operation of which an abnormality has occurred can be identified, the power supply control module 26 may reset only the log obtaining target device. If the watchdog ignition flag is set as a result of timeout of the counter of the watchdog timer module 24, for example, the power supply control module 26 may reset only the monitored processor 12. If the watchdog timer module 24 receives the above-described abnormality signal, the power supply control module 26 may reset only a log obtaining target device indicated by the received signal. When the watchdog timer module 24 sets watchdog ignition flags of different types for different log obtaining target devices in operation of which an abnormality has occurred, the power supply control module 26 can identify, on the basis of a watchdog ignition flag, a log obtaining target device in operation of which an abnormality has occurred.

As a result of the reset control, the log obtaining target device in the operation of which an abnormality has occurred is restarted, and a proper operation is expected to be performed.

As described above, the watchdog timer module 24 does not issue a reset request when the watchdog ignition flag is set but issues a reset request after the watch dog ignition flag is set and the log obtaining module 22 stops obtaining log information. That is, the power supply control module 26 performs the above-described reset control after the log obtaining module 22 stops obtaining log information. As a result of the reset control, a log obtaining target device is restarted, but the log obtaining module 22 does not obtain log information at this time on the basis of the log latch flag. As a result, the log memory 22a maintains log information obtained from the log obtaining target device when an abnormality occurred in the operation of the log obtaining target device.

After the power supply control module 26 performs the reset control, the monitored processor 12 reads the log information from the log memory 22a and stores the log information in the nonvolatile memory 16. More specifically, after restarting, the monitored processor 12 determines whether the log latch flag is set and, if the log latch flag is set, reads the log information from the log memory 22a and stores the log information in the nonvolatile memory 16. If the log latch flag is not set, the monitored processor 12 does not read the log information from the log memory 22a.

By storing log information in the nonvolatile memory 16, log information regarding a log obtaining target device at a time when an abnormality occurred in operation of the log obtaining target device can be maintained even after the information processing apparatus 10 is turned off. The monitored processor 12 may store the log information read from the log memory 22a in a nonvolatile memory outside the information processing apparatus 10. For example, the monitored processor 12 may transmit the log information read from the log memory 22a to an external server through a communication interface (not illustrated) included in the information processing apparatus 10 and store the log information in a nonvolatile memory included in the server.

After reading the log information from the log memory 22a and storing the log information in the nonvolatile memory 16, the monitored processor 12 transmits a log information transfer completion notification to the processor 20. The log obtaining module 22 clears the log latch flag (e.g., deletes the log latch flag from the log memory 22a) on the basis of the log information transfer completion notification from the monitored processor 12 and starts to obtain the log information again.

The watchdog timer module 24 clears the watchdog ignition flag (deletes the watchdog ignition flag from the ignition flag memory 24a) on the basis of the log information transfer completion notification from the monitored processor 12 and starts to monitor the watchdog ignition flag. The watchdog timer module 24 starts to monitor the monitored processor 12 on the basis of the log information transfer completion notification from the monitored processor 12 (i.e., after the monitored processor 12 reads the log information from the log memory 22a and stores the log information in the nonvolatile memory 16) in order to avoid an event where the reset control is repeatedly performed on the basis of the watchdog ignition flag when it is difficult to restart the monitored processor 12 properly.

An outline of the configuration of the information processing apparatus 10 according to the present exemplary embodiment is as described. With the information processing apparatus 10, the reset control is performed not immediately after the watchdog ignition flag is set but after the log obtaining module 22 stops obtaining log information. As a result, new log information is no longer written to the log memory 22a (e.g., after the restart based on the reset control), and the log memory 22a can maintain log information at a time when an abnormality occurred in operation of a log obtaining target device.

In the information processing apparatus 10, the log obtaining module 22 is provided for the log obtaining module 22, which is different from the monitored processor 12, which is the log obtaining target device. As a result, log information at a time when the monitored processor 12 is turned on can be obtained. If the log obtaining module 22 were provided for the monitored processor 12, only log information after the monitored processor 12 was turned on and communication between the monitored processor 12 and a memory for storing log information was established could be obtained.

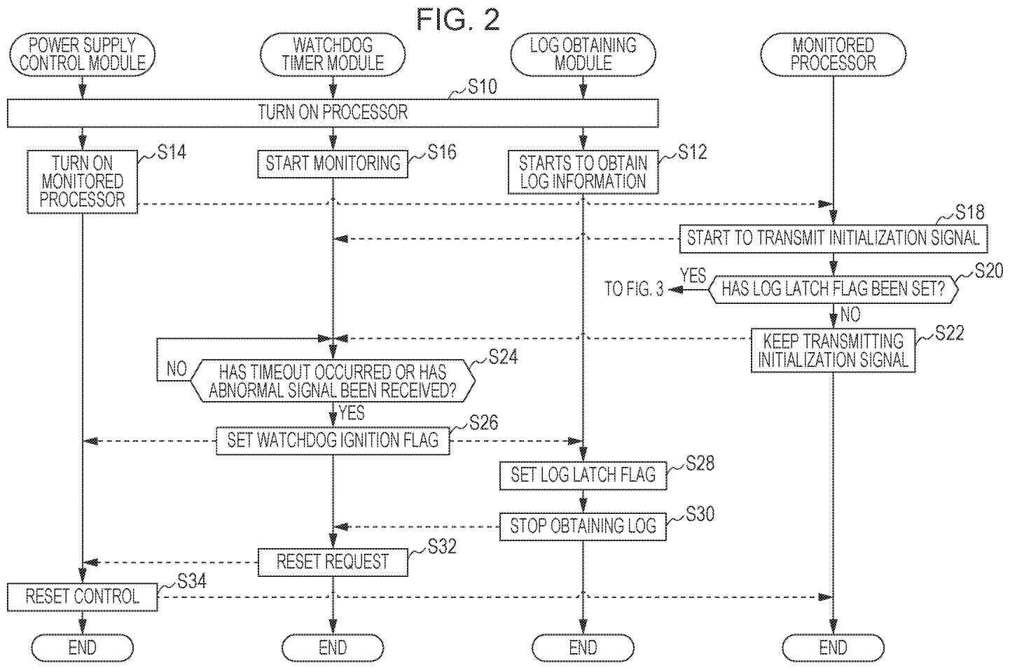

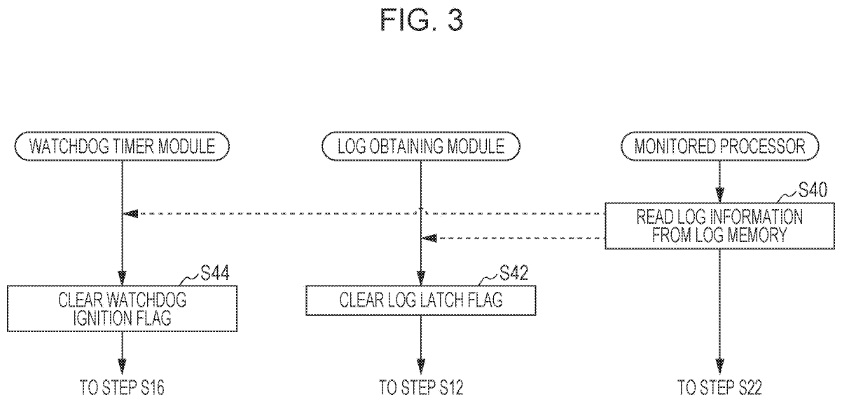

A process performed by the information processing apparatus 10 will be described with reference to flowcharts of FIGS. 2 and 3.

FIG. 2 is a flowchart illustrating a process that ends with the reset control.

In step S10, power is supplied to the processor 20 (i.e., the log obtaining module 22, the watchdog timer module 24, and the power supply control module 26) prior to a log obtaining target device.

In step S12, the log obtaining module 22 obtains log information regarding the log obtaining target device. The log obtaining module 22 sequentially obtains the log information and stores the log information in the log memory 22a.

In step S14, the power supply control module 26 supplies power to the monitored processor 12. At the same time, in step S16, the watchdog timer module 24 starts to monitor the monitored processor 12. That is, the watchdog timer module 24 starts to count the counter value.

In step S18, the monitored processor 12 starts to transmit the initialization signal to the watchdog timer module 24 immediately after power is supplied thereto.

In step S20, the monitored processor 12 accesses the log memory 22a and determines whether the log memory 22a stores the log latch flag set by the log obtaining module 22. The log latch flag has been set in step S20 if the power supply control module 26 has restarted the monitored processor 12 as a result of occurrence of an abnormality in operation of the log obtaining target device. If the log memory 22a stores the log latch flag, the process proceeds to the flowchart of FIG. 3, which will be referred to later. It is assumed here that the log latch flag has not been set, and in step S22, the monitored processor 12 continues to transmit the initialization signal as long as operating properly.

In step S24, the watchdog timer module 24 determines whether timeout has occurred (the counter value has reached 0) or an abnormality signal has been received from the monitored processor 12. That is, the watchdog timer module 24 determines whether an abnormality has occurred in the operation of the log obtaining target device. If an abnormality has occurred in the operation of the log obtaining target device, the process proceeds to step S26.

In step S26, the watchdog timer module 24 sets the watchdog ignition flag and stores the watchdog ignition flag in the ignition flag memory 24a. The watchdog timer module 24 also notifies the log obtaining module 22 and the power supply control module 26 that the watchdog ignition flag has been set.

In step S28, the log obtaining module 22 sets the log latch flag on the basis of the watchdog ignition flag and stores the log latch flag in the log memory 22a.

In step S30, the log obtaining module 22 stops obtaining the log information. That is, the log obtaining module 22 stops obtaining the log information before the log obtaining target device is reset. As a result, the log memory 22a maintains the log information obtained so far.

In step S32, the watchdog timer module 24 issues a reset request to the power supply control module 26. That is, the watchdog timer module 24 issues a reset request after the log obtaining module 22 stops obtaining the log information.

In step S34, the power supply control module 26 performs the reset control for resetting the log obtaining target device.

FIG. 3 is a flowchart illustrating a process performed when the log latch flag has been set in step S20.

In step S40, the monitored processor 12 reads the log information from the log memory 22a and stores the log information in the nonvolatile memory 16. After storing the log information in the nonvolatile memory 16, the monitored processor 12 transmits a log information transfer completion notification to the processor 20 (i.e., the log obtaining module 22 and the watchdog timer module 24). The process then returns to step S22, and the monitored processor 12 continues to transmit the initialization signal to the watchdog timer module 24 as long as operation properly.

In step S42, the log obtaining module 22 clears the log latch flag (deletes the log latch flag from the log memory 22a) in accordance with the log information transfer completion notification from the monitored processor 12. The process then returns to step S12, and the log obtaining module 22 starts to obtain the log information again.

In step S44, the watchdog timer module 24 clears the watchdog ignition flag (deletes the watchdog ignition flag from the ignition flag memory 24a) in accordance with the log information transfer completion notification from the monitored processor 12. The process then returns to step S16, and the watchdog timer module 24 continues to monitor the monitored processor 12.

Although an exemplary embodiment of the present disclosure has been described, the present disclosure is not limited to the above exemplary embodiment, and may be modified in various ways without deviating from the scope of the present disclosure.

For example, although the processor 20 achieves the functions of the log obtaining module 22, the watchdog timer module 24, and the power supply control module 26 in the present exemplary embodiment, separate processors may achieve these modules, instead. That is, the information processing apparatus 10 may include a first processor that achieves the function of the log obtaining module 22, a second processor that achieves the function of the watchdog timer module 24 and that is different from the first processor, and a third processor that achieves the function of the power supply control module 26 and that is different from the first and second processors.

The monitored processor 12 may achieve the functions of the log obtaining module 22, the watchdog timer module 24, and the power supply control module 26, instead. In this case, it is difficult for the log obtaining module 22 to obtain log information at a time when the monitored processor 12 is turned on, but the log obtaining module 22, the watchdog timer module 24, and the power supply control module 26 in the monitored processor 12 can perform the above-described process as long as operating properly. The watchdog timer module 24, for example, can detect occurrence of an abnormality in operation of parts of the monitored processor 12 other than the watchdog timer module 24. The power supply control module 26 may reset at least parts of the monitored processor 12 other than the log memory 22a.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus including:
a log memory; and
a processor configured to:
   obtain log information indicating an operation status of a log obtaining target device, which is at least a monitored processor or a peripheral device, which is a device in the information processing apparatus other than the monitored processor, and store the log information in the log memory;
   set a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor;
   stop, on a basis of the flag, obtaining the log information and cause the log memory to maintain the log information obtained so far before the log obtaining target device in the operation of which the abnormality has occurred is reset; and
   perform, without resetting the log memory after stopping obtaining the log information, reset control for resetting the log obtaining target device in the operation of which the abnormality has occurred.
      (((2)))

The information processing apparatus according to (((1))),
in which the processor is different from the monitored processor and starts to obtain the log information before power is supplied to the monitored processor.
   (((3)))

The information processing apparatus according to (((1))),
in which the monitored processor reads, after the reset control is performed, the log information from the log memory and stores the log information in a nonvolatile memory.
   (((4)))

A program causing a computer including a log memory to execute a process for processing information, the process including:
obtaining log information indicating an operation status of a log obtaining target device, which is at least a monitored processor or a peripheral device, which is a device in the information processing apparatus other than the monitored processor, and store the log information in the log memory;
setting a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor;
stopping, on a basis of the flag, obtaining the log information and causing the log memory to maintain the log information obtained so far before the log obtaining target device in the operation of which the abnormality has occurred is reset; and
performing, on a basis of the flag without resetting the log memory, reset control for resetting the log obtaining target device in the operation of which the abnormality has occurred.
   (((5)))

An information processing apparatus including:
a first processor that achieves a function of a log obtaining module;
a second processor that achieves a function of a timer module;
a third processor that achieves a function of a reset control module; and
a log memory,
in which the first processor obtains log information indicating an operation status of a log obtaining target device, which is at least a monitored processor or a peripheral device, which is a device in the information processing apparatus other than the monitored processor, and stores the log information in the log memory,
in which the second processor sets a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor,
in which the first processor stops, on a basis of the flag, obtaining the log information and causes the log memory to maintain the log information obtained so far before the log obtaining target device in the operation of which the abnormality has occurred is reset, and
in which the third processor performs, on a basis of the flag without resetting the log memory, reset control for resetting the log obtaining target device in the operation of which the abnormality has occurred.

What is claimed is:

1. An information processing apparatus comprising:
a log memory; and
a processor configured to:
obtain log information indicating an operation status of a log obtaining target device, which is at least a monitored processor or a peripheral device, which is a device in the information processing apparatus other than the monitored processor, and store the log information in the log memory;
set a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor;
stop, on a basis of the flag, obtaining the log information and cause the log memory to maintain the log information obtained so far before the log obtaining target device in the operation of which the abnormality has occurred is reset; and
perform, without resetting the log memory after stopping obtaining the log information, reset control for resetting the log obtaining target device in the operation of which the abnormality has occurred.

2. The information processing apparatus according to claim 1,
wherein the processor is different from the monitored processor and starts to obtain the log information before power is supplied to the monitored processor.

3. The information processing apparatus according to claim 1,
wherein the monitored processor reads, after the reset control is performed, the log information from the log memory and stores the log information in a nonvolatile memory.

4. A non-transitory computer readable medium storing a program causing a computer including a log memory to execute a process for processing information, the process comprising:
obtaining log information indicating an operation status of a log obtaining target device, which is at least a monitored processor or a peripheral device, which is a device in the information processing apparatus other than the monitored processor, and store the log information in the log memory;
setting a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor;
stopping, on a basis of the flag, obtaining the log information and causing the log memory to maintain the log information obtained so far before the log obtaining target device in the operation of which the abnormality has occurred is reset; and
performing, on a basis of the flag without resetting the log memory, reset control for resetting the log obtaining target device in the operation of which the abnormality has occurred.

5. An information processing apparatus comprising:
a first processor that achieves a function of a log obtaining module;
a second processor that achieves a function of a timer module;
a third processor that achieves a function of a reset control module; and
a log memory,
wherein the first processor obtains log information indicating an operation status of a log obtaining target device, which is at least a monitored processor or a peripheral device, which is a device in the information processing apparatus other than the monitored processor, and stores the log information in the log memory,
wherein the second processor sets a flag indicating occurrence of an abnormality in operation of the log obtaining target device in accordance with absence of an initialization signal input from the monitored processor within a certain period or an abnormality signal indicating occurrence of an abnormality in operation of the peripheral device input from the monitored processor,
wherein the first processor stops, on a basis of the flag, obtaining the log information and causes the log memory to maintain the log information obtained so far before the log obtaining target device in the operation of which the abnormality has occurred is reset, and
wherein the third processor performs, on a basis of the flag without resetting the log memory, reset control for resetting the log obtaining target device in the operation of which the abnormality has occurred.
